(19) United States
(12) Patent Application Publication
(10) Pub. No.: US 2007/0043147 A1
(43) Pub. Date: Feb. 22, 2007

(54) PARTICULATE POLYMERIC MATERIAL

(75) Inventors: John M. Higgins, Pinner (GB); Ian M. Newington, High Wycombe (GB)

Correspondence Address: Paul A. Leipold, Patent Legal Staff;Eastman Kodak company, 343 State Street, Rochester, NY, 14650-2201, US

(73) Assignee: Eastman Kodak Company

(21) Appl. No.: 11/464,890

(22) Filed: Aug. 16, 2006

(30) Foreign Application Priority Data
Aug. 16, 2005 (GB) 0516761.4

(51) Int. Cl. C03C 17/00

(52) U.S. Cl. 523/160

(57) ABSTRACT

A polymeric particulate material suitable for use in an ink-jet receiver is prepared by generating an emulsion comprising a first phase having a first carrier fluid and a second phase having a second carrier fluid, said first and second carrier fluids being immiscible; carrying out a first treatment to at least one component of the first phase to form and/or maintain a skeletal structure of the treated at least one component of the first phase; carrying out a second treatment to the second phase to substantially remove the carrier fluid thereby generating a large capacity porous structure defined by the skeletal structure; and mechanically dividing (e.g. milling) the skeletal structure. A coating of the particles is capable of rapid uptake of large quantities of ink, especially when formed using a high internal phase water-in-oil emulsion.

### FIELD OF THE INVENTION

The present invention relates to a novel method of making particles of polymeric material and more particularly to their use in manufacturing ink-jet receivers. The invention is particularly concerned with improved ink-receiving layers having rapid ink uptake and large capacity. More specifically, the present invention relates to the use of emulsions to generate porous polymer structures from which particles formed therefrom may be used in the manufacture of porous ink-jet receivers.

### BACKGROUND OF THE INVENTION

Ink-jet receivers are generally classified in one of two categories according to whether the principal component material forms a layer that is “porous” or “non-porous” in nature. Many commercial photo-quality porous receivers are made using a relatively low level of a polymeric binder to lightly bind inorganic particles together to create a network of interstitial pores which absorb ink by capillary action. These receivers can appear to dry immediately after printing. However, relatively thick layers are usually required, sometimes as much as 50 μm, to provide sufficient fluid capacity. As the component materials are relatively dense, large masses of material are needed and the layers are often prone to cracking and brittleness.

Non-porous receivers are made up of polymeric layers that are capable of absorbing relatively large amounts of ink by molecular diffusion. The main problem with this type of receiver is that the diffusion process is relatively slow and the receivers can take a considerable time before they appear dry.

A porous polymer material may be a suitable material for use in an ink-jet receiver. Methods for making porous polymer materials have been known for some time, although difficulties in conveniently making porous materials with suitable physical properties, without involving the use of significant quantities of volatile organic materials, particularly to create porosity, would be likely to prove disadvantageous in making ink-jet receivers, especially in large scale manufacture.

However, porous polymeric foams obtained by polymerising a polymerisable monomer in a high internal phase emulsion (HIPE) are known and their use as industrial filters, as supports in synthesis and cell growth and as absorbant materials for sanitary articles has been described.

WO-A-97/37745 describes a method of preparing a filter material, for use as a bag filter, for example, by impregnating a high internal phase emulsion, comprising a polymerisable monomer in the continuous phase, into a porous substrate, such as a felt material, and polymerising the polymerisable monomers to form a cured foam within the felt material. The filter material formed can comprise mean pore sizes of between about 1 and 100 μm. The small pore size and high degree of porosity of the material formed results in a significant reduction in the pressure drop across the filter material.

U.S. Pat. No. 5,817,704 describes a HIPE-derived heterogeneous polymeric foam structure of interconnecting cells, obtained by polymerising polymerisable monomers from at least two distinct HIPEs in a mixture, for use to absorb and store liquids in sanitary articles.

WO-A-97/27240 describes a method of preparing foams from HIPEs by coating a HIPE continuously onto a continuous moving strip of relatively inert polymeric film, such as polypropylene, spooling the coated polymeric film and heat curing the HIPE on the coated, spooled film. The foam can then be unspooled and removed from the polymeric film.

It is desirable to form a material from which an ink-receiving layer for an ink-jet receiver can be formed, which absorbs large quantities of ink rapidly. It is further desirable that the ink-receiving layer is sufficiently thin that the sharpness of the printed image is maintained. It is still further desirable that an ink-receiving layer is conveniently manufactured.

### PROBLEM TO BE SOLVED BY THE INVENTION

It is, therefore, an object of the invention to provide a novel material for use in making an ink-receiving layer for an ink-jet receiver, which enables rapid uptake of ink and provides high capacity.

It is a further object of the invention to prepare such an ink-receiving layer economically and efficiently and, therefore, from the minimum of material.

### SUMMARY OF THE INVENTION

According to a first aspect of the invention, there is provided a process for the preparation of a polymeric particulate material, said process comprising generating an emulsion comprising a first phase having a first carrier fluid and a second phase having a second carrier fluid, said first and second carrier fluids being immiscible; carrying out a first treatment to at least one component of the first phase to form and/or maintain a skeletal structure of the treated at least one component of the first phase; and carrying out a second treatment to the second phase to substantially remove the carrier fluid, thereby generating a large capacity porous polymeric structure defined by the skeletal structure and then mechanically dividing the porous polymeric structure to form polymeric particles.

According to a second aspect of the invention, there is provided a process for the manufacture of an ink-jet receiver comprising a support and a porous fluid receiving layer, said process comprising coating onto a support a coating composition comprising a binder material and a plurality of polymeric particles obtainable by the above process.

According to a third aspect of the invention, there is provided an ink-jet receiver obtainable by the process according to the second aspect of the invention above.

According to a fourth aspect of the invention, there is provided a method of printing, said method comprising the steps of providing an ink-jet printer responsive to electronic data signals, loading the ink-jet printer with an ink-jet receiver as defined above and causing electronic data signals, corresponding to a desired image to be printed, to be sent to the ink-jet printer, said ink-jet printer responding by printing the image onto the inkjet receiver.

### ADVANTAGEOUS EFFECT OF THE INVENTION

The process of the present invention provides a polymeric particulate material that is capable of being coated onto a support to a form a receiving layer for an ink-jet receiver, which is capable of rapid uptake of large amounts of ink due to the use of relatively low density, particles formed from the skeletal structure of a porous polymer material.

### BRIEF DESCRIPTION OF THE DRAWINGS

FIG. 1 shows a cross-sectional SEM of a porous polymeric liquid-receiving layer of an ink-jet receiver prepared by heat curing a HIPE-coated support, according to the present invention.

FIG. 2 shows a cross-sectional SEM of a porous polymeric liquid-receiving layer of an ink-jet receiver prepared by heat curing a HIPE-coated support, according to the present invention in which the HIPE is mixed at a shear rate of 2000 rpm.

FIG. 3 shows a cross-sectional SEM of a porous polymeric liquid-receiving layer of an ink-jet receiver prepared by heat curing a HIPE-coated support, according to the present invention in which the HIPE is mixed at a shear rate of 4000 rpm.

FIG. 4 shows a cross-sectional SEM of a porous polymeric liquid-receiving layer prepared by heat curing a HIPE-coated support, according to the present invention in which the HIPE is mixed at a shear rate of 6000 rpm.

FIG. 5 shows a graph of mean pore diameter (μm) versus shear rate (rpm) for porous polymeric liquid-receiving layers of ink-jet receivers prepared by heat curing a HIPE-coated support, according to the present invention.

FIG. 6 shows a cross-sectional SEM of a porous polymeric liquid-receiving layer of an ink-jet receiver prepared by heat curing a HIPE-coated support according to the present invention, which HIPE contained a porogen in the continuous phase.

FIG. 7 shows a top view SEM of a porous polymeric liquid-receiving layer of an ink-jet receiver prepared by heat curing a HIPE-coated support according to the present invention, in which the polymerisation initiator precursor was AIBN.

FIG. 8 shows a top view SEM, at a magnification of 5000×, of a porous polymeric liquid-receiving layer of an ink-jet receiver prepared by heat curing a HIPE-coated support according to the present invention, in which the HIPE was coated onto the support by extrusion coating.

FIG. 9 shows a cross-sectional SEM, at a magnification of 625×, of a porous polymeric liquid-receiving layer of an ink-jet receiver prepared by heat curing a HIPE-coated support according to the present invention, in which the HIPE was coated onto the support by extrusion coating.

FIG. 10 shows a top view SEM, at a magnification of 5000×, of a porous polymeric liquid-receiving layer of an ink-jet receiver prepared by heat curing a HIPE-coated support, in which the HIPE was coated onto the support by extrusion coating at a slow extrusion rate (7 ml/min).

FIG. 11 shows a cross-sectional SEM, at a magnification of 2000×, of a porous polymeric liquid-receiving layer of an ink-jet receiver prepared by coating 15 g/m² polyHIPE, particles prepared according to Example 17, with PVA as binder (in a ratio of 85:15) onto a paper support according.

FIG. 12 shows another cross-sectional SEM, at a magnification of 2000×, of a porous polymeric liquid-receiving layer of an ink-jet receiver prepared by coating 15 g/m² polyHIPE particles, prepared according to Example 18, with PVA as binder (in a ratio of 85:15) onto a paper support.

FIG. 13 shows the particle size distribution in a graph of volume/% against particle diameter/μm of particles formed according to Example 17 below, as measured using a Coulter Counter.

FIG. 14 shows the particle size distribution in a graph of volume/% against particle diameter/μm of particles formed according to Example 18 below, as measured using a Coulter Counter.

### DETAILED DESCRIPTION OF THE INVENTION

The emulsion used to put the present invention into effect is preferably a biphasic emulsion, typically comprising two liquid phases, which may be two immiscible oil phases, but is preferably a water-in-oil or an oil-in-water emulsion. One of the phases may be treated to form an integral or skeletal structure such that on removal of the other phase, or of a large portion, for example the carrier fluid, of the other phase of the emulsion, the integrity of the structure of the first phase in the emulsion is largely maintained, thereby forming a porous structure.

Preferably one of the phases of the emulsion—the phase to be treated such that a skeletal structure is formed—comprises a polymerisable monomer which may be treated by initiating a polymerisation reaction to form an integral polymeric structure throughout that phase, which structure remains largely intact on removal of the carrier fluid of the other phase. Alternatively, the phase of the emulsion to be treated such that a skeletal structure is formed may comprise a soluble polymer, which may be treated by initiating a cross-linking reaction. Suitable soluble polymers include polymers of intrinsic microporosity (PIMs) such as those described in McKeown et al (J. Chem. Soc., Chem. Commun., 2004, 230-231), the disclosure of which is incorporated herein by reference.

In a preferred embodiment of the invention, the emulsion used according to the present invention is a high internal phase emulsion (HIPE). A high internal phase emulsion is a term known in the art and refers to emulsions in which the internal phase is present in an amount greater than would normally be expected, according to spherical close-packing, before inversion of the phases occurs. For example, under normal circumstances, in an oil-in-water emulsion, when the amount of the internal phase (in this case, oil) exceeds 75.04% by volume, the emulsion would undergo phase inversion to form a water-in-oil emulsion, or vice versa. A high internal phase emulsion is an emulsion which, for some reason, when the internal phase exceeds 75.04% does not undergo phase inversion.

Usually such high internal phase emulsions require stabilisation to prevent phase inversion. For example, the emulsion may be stabilised by incorporating a suitable surfactant into the emulsion.

According to the preferred embodiment, the continuous phase (external phase) of the high internal phase emulsion preferably comprises a component, such as a polymerisable monomer, which may be treated, for example by initiating a polymerisation reaction, so that a skeletal structure is formed which substantially maintains the geometrical form of the continuous phase of the emulsion. The carrier fluid of the internal phase may then be removed to reveal a highly porous skeletal structure. Such a skeletal structure prepared from a HIPE shall be referred to herein as a polyHIPE structure.

A particular advantage of treating the continuous phase of a high internal phase emulsion to form a skeletal structure is that the internal phase of a high internal phase emulsion defines cavities with a high degree of interconnectivity. Particular advantages of this are that the carrier fluid of the internal phase can be rapidly removed from the structure formed by treatment of the continuous phase and that it allows the formation from such a structure of highly irregular and porous polymeric particles, which are useful for a variety of applications, but particularly useful in making porous ink receivers.

When a high internal phase emulsion is formed from an aqueous phase and an oil phase, an oil-in-water HIPE (high internal phase emulsion) may be used in which a component in the aqueous phase is treated to form an integral structure defined by the structure of the aqueous phase in the emulsion. Preferably, however, a water-in-oil HIPE is utilised.

According to the embodiment of the invention in which a water-in-oil HIPE is utilised, a component of the oil phase, which may be the carrier fluid, is preferably a polymerisable monomer that may be treated by initiating a polymerisation reaction.

The polymerisable monomer may be any suitable monomer capable of forming a polymer under reaction conditions that can be carried out in an emulsion. Suitable monomers for use according to the present embodiment include monomers having a polymerisable vinyl group such as: monoalkenyl arene monomers, for example α-methylstyrene, chloromethylstyrene, vinylethylbenzene and vinyl toluene; acrylate and methacrylate esters, for example 2-ethylhexyl acrylate, n-butyl acrylate, isobutyl acrylate, t-butyl acrylate, hexyl acrylate, n-butyl methacrylate, lauryl methacrylate, and isodecyl methacrylate; conjugated diolefins such as butadiene, isoprene, and piperylene; allenes, for example allene, methyl allene and chloroallene; olefin halides, for example vinyl chloride, vinyl fluoride; and polyfluoro-olefins. A preferred polymerisable monomer according to the present invention is styrene. In any case, it is preferable that the polymerisable monomer according to the present embodiment has a low solubility in water, and more preferably is insoluble in water.

Optionally, the oil phase may comprise two or more polymerisable monomers, which monomers may, for example, be selected from the above list of monomers, so as to form a copolymer therefrom following the polymerisation reaction.

Preferably, in order to confer a degree of rigidity into the skeletal structure formed, a cross-linker may be incorporated into the oil phase. Suitable cross-linking agents may be any multifunctional unsaturated monomer capable of reacting with the polymerisable monomer. Such cross-linking agents contain at least two functional groups, which functional groups may be selected from, for example, vinyl groups, acrylate groups and methacrylate groups. The cross-linking monomers may include, for example, difunctional unsaturated cross-linking monomers such as divinylbenzene, diethylene glycol dimethacrylate, 1-3-butanediol dimethacrylate, and allyl methacrylate and tri-, tetra- and penta-functional unsaturated cross-linking monomers such as trimethylolpropane trimethacrylate, pentaerythritol tetramethacrylate, trimethylolpropane triacrylate and pentaerythritol tetra-acrylate, glucose pentaacrylate, glucose diethylmercaptal pentaacrylate, and sorbitan triacrylate; and poly-functional unsaturated cross-linking monomers such as polyacrylates (e.g. sucrose per(meth)acrylate and cellulose(meth)acrylate). The preferred cross-linkers are divinyl benzene and 1,4-butanediol dimethacrylate, preferably divinyl benzene. In order to achieve an acceptable balance between the degree of rigidity of the integral structure to enable effective milling in forming particles therefrom and the flexibility of an ink-jet receiver formed from such polymer particles, the relative amount of cross-linker to polymerisable monomer is preferably in the range of from 0.5 wt % (weight percent) to 70 wt %, more preferably from 2 wt % to 40 wt % and still more preferably from 5 wt % to 20 wt %.

Specific properties, including rate of polymerisation, flexibility, bulk, rigidity and brittleness may be controlled by varying the relative amounts of polymerisable monomers and of cross-linking agent and may depend on the specific identity of these components.

According to the present embodiment, in which a water-in-oil HIPE is utilised and the oil phase comprises a polymerisable monomer, the first treatment carried out to the at least one component (the polymerisable monomer) so that a skeletal structure is formed, is the initiation of a polymerisation reaction.

The initiation of the polymerisation reaction may be by simply heating the emulsion comprising a polymerisable monomer composition, by irradiation with UV or other electromagnetic irradiation, but preferably the initiation of the polymerisation reaction comprises heating the emulsion to form a polymerisation initiator species, e.g. a radical initiator, from an initiator precursor present in the emulsion. Examples of suitable initiator precursors include oil soluble initiator precursors and water soluble initiator precursors. Suitable water soluble initiator precursors include, for example, persulfates such as potassium or sodium persulfate, and redox coupler initiator systems such as ammonium persulfate together with sodium metabisulfite. Suitable oil soluble initiator precursors include, for example, azo compounds such as azobisisobutyronitrile; and peroxides such as benzoyl peroxide, methyl ethyl ketone peroxide, alkylperoxycarbonates such as di-2-ethylhexyl peroxy-dicarbonate and di(sec-butyl)peroxydicarbonate and alkyl peroxycarboxylates such as t-butyl peroxyisobutyrate, 2,5-dimethyl-2,5-bis(2,3-ethylhexanoylperoxy)hexane, and t-butyl peroctoate. Preferable alkylperoxycarbonates are branched at the 1-position and preferable alkylperoxycarboxylates are branched at the α-position and/or 1-position. Examples of branched alkylperoxycarbonates and alkylperoxycarboxylates are described in WO-A-9737745 (page 8, line 14 to page 9, line 5), which disclosure is incorporated herein by reference. The preferred initiator precursor according to the present invention are one or more of potassium persulfate, AIBN (azobisisobutyronitrile), and a redox couple initiator system comprising, for example, ammonium persulfate and sodium metabisulfite. The initiator precursor may form part of the oil phase (e.g. AIBN) or the aqueous phase (e.g. potassium persulfate or an aqueous redox coupling system) or both (e.g. AIBN in the oil phase and potassium persulfate in the aqueous phase), but preferably the initiator precursor forms part of the aqueous phase. Without being bound by theory, it is believed that by initiating the polymerisation reaction using an initiator in the aqueous phase, the polymer is first formed at the boundary between the oil and aqueous phases leading to better maintenance of the integral structure of the oil phase on completion of the polymerisation reaction, as compared with an initiator in the oil phase which may result in some distortion of the integral structure of the emulsion on completion of the reaction.

Nevertheless, it may be that the presence of an initiator precursor in both the oil phase and the aqueous phase may be preferred in order to ensure more rapid completion of the polymerisation reaction, which may be of particular benefit from a large scale manufacturing point of view.

The amount of the initiator precursor present and the temperature applied determines the average chain length in linear polymer systems; the more initiator, the more radicals are generated at any one time. Preferably, the initiator precursor is present in an amount of from 0.5 to 10 wt %, more preferably 1 to 7 wt % and most preferably 3 to 5 wt % based on the amount of polymerisable monomer present.

The temperature applied during the polymerisation step (or curing step) is preferably in the range 40-120° C., more preferably 50-90° C. and most preferably 60-80° C. The time for the polymerisation step is typically inversely related to the temperature applied. For example, in a preferred embodiment, the polymerisation stage involves heating to 65-70° C. for a period of 4-6 hours. After the polymerisation step, the polyHIPE material formed is preferably treated, by drying, in order to remove water by evaporation. Preferably the polyHIPE is dried at 65-70° C. for 2-4 hours.

As mentioned above, a high internal phase emulsion is usually stabilised by a surfactant. For water-in-oil emulsions, it is necessary for such a surfactant to be soluble in the oil phase and suitable such surfactants may be determined according to the hydrophilic-lipophilic balance (HLB value) of a surfactant. Typically, suitable surfactants have very limited solubility in the internal phase (e.g. the aqueous phase of a water-in-oil emulsion) in order that they can adequately stabilise the high internal phase emulsion and prevent phase inversion occurring spontaneously. Preferably, the surfactant has an HLB value in the range of from 2 to 6 and preferably is about 4. The surfactant may be non-ionic, cationic, anionic or amphoteric provided that the surfactant or combination of surfactants are effective to form a stable high internal phase emulsion. Preferred types of surfactants that can be used to stabilise water-in-oil HIPEs include sorbitan fatty acid esters, polyglycerol fatty acid esters, polyoxyethylene fatty acids and esters. Examples of sorbitan fatty acids esters include sorbitan monolaurate (available as SPAN® 20), sorbitan monooleate (SPAN® 80) and combinations of sorbitan monoleate (SPAN® 80) with sorbitan trioleate (SPAN® 85). One such surfactant combination of sorbitan fatty acid esters is the combination of sorbitan monooleate and sorbitan trioleate in a weight ratio greater than or equal to 3:1, more preferably 4:1. Other suitable surfactants are “TRIODAN® 20”, which is a polyglycerol ester available from Grindsted®, and “EMSORB™ 252”, which is a sorbitan sesquioleate available from Henkel®.

Preferred surfactants according to a preferred embodiment include, for example, sorbitan monooleate and glycerol monooleate. Sorbitan monooleate is a particularly preferred surfactant because it can also act as an ozone scavenger which has the benefit that in, for example a resulting ink-jet receiver, the surfactant can help postpone the onset of any ozone induced fade.

The surfactant may be present in the emulsion in an amount of from 1 to 50 wt %, preferably 5 to 40 wt %, more preferably 15 to 40 wt %, still more preferably 20 to 35 wt % and most preferably 25 to 33 wt % based on the amount of polymerisable monomer present. Where sorbitan fatty acid esters are used as a component of the surfactant, the sorbitan fatty acid ester surfactants are preferably present in an amount of from 2 to 36 wt %, more preferably from 5 to 25 wt %.

Preferably, according to the present embodiment of the invention in which a water-in-oil HIPE is utilised, the oil phase comprises a polymerisable monomer, a surfactant and optionally a cross-linker. The carrier fluid may be the polymerisable monomer or a mixture of the components or may be an additional solvent, but preferably comprises the polymerisable monomer. The aqueous phase comprises water, as the carrier fluid, and optionally an electrolyte, for additional stabilisation of the emulsion.

Suitable electrolytes include inorganic salts (monovalent, divalent, trivalent or mixtures thereof), for example, alkali metal salts, alkaline earth metal salts and heavy metal salts, which may be halides, sulfates, carbonates, phosphates and mixtures thereof. Preferably, a suitable electrolyte comprises one or more of sodium chloride, sodium sulfate, potassium chloride, potassium sulfate, lithium chloride, magnesium chloride, calcium chloride, magnesium sulfate and aluminium chloride. Preferably, the electrolyte is calcium chloride.

Additional components may be added to the second phase to provide improved properties to the resulting polymer particles and to a fluid-receiving layer of an ink-jet receiver prepared therefrom. Such additional components may be, for example, swellable polymers or other materials capable of absorbing ink and/or protecting ink from environmental factors. By incorporating such additional components into the second phase of the emulsion, these components may be evenly coated onto the surface of the skeletal structure on removal of the second carrier fluid such that, after milling, these components are present on the surface of the resulting particles. Where the second phase is an aqueous phase, such as in a preferred embodiment utilising a high internal phase water-in-oil emulsion, additional components that may be included in the aqueous phase to modify the properties of the resulting particles include, for example, polyvinyl alcohol (PVA) or other aqueous soluble swellable polymer material, so that on removal of the second carrier fluid (water), the PVA or other polymer material forms a thin coating on the internal surface of the resultant skeletal polymer structure and a partial coating on the resulting milled particles. Similarly, a coating of a mordant material may be formed by incorporating a mordant into the second phase. Examples of useful mordants, for stabilising absorbed ink and improving image density, include [3-(methacryloylamino)propyl]trimethylammonium chloride.

Other additional components that may be added to the second phase include, for example, stabilisers for dyes and/or pigments against degradation by, for example, light or ozone, UV absorbers, sequestering agents, surfactants, polymeric binders, etc.

The inventors have found that particles of polyHIPEs obtained by mechanically dividing or milling the bulk material of the porous polymeric structure may be coated, with suitable addenda, as a thin layer onto a support to form a fluid-receiving layer of an ink-jet receiver, especially an ink-receiving layer. PolyHIPE materials have been found to be advantageous as their skeletal structure easily enables the formation of small, amorphous, low density particles that pack loosely to form effective fluid receiving layers. Where the pore size of the polyHIPE structure is small relative to the size of the polymeric particles formed from the polyHIPE structure, the particles will have some degree of internal porosity thereby being capable of producing still more efficient fluid-receiving layers.

The ease with which small particles can be obtained depends upon several factors, such as porosity, pore size and the effectiveness of the material reduction or mechanical division process. Highly porous polyHIPE structures, for example, allow the formation of large pore sizes and yet still produce slender skeletal structures, facilitating the easy production of small particles. Low porosity structures need much smaller pore sizes, which are often more difficult to obtain conveniently, to obtain small particles with the same ease.

One of the factors that can contribute to the ease with which small particles are obtained is the relative amounts of the first and second phases of the emulsion from which the skeletal structure is formed, since the particles are formed from the skeletal structure. For example, for a water-in-oil HIPE to result in a polyHIPE material with a porosity of 80%, it is required that the HIPE comprises 20% oil phase and 80% aqueous phase. Therefore, by increasing the relative amount of the second phase in the emulsion, the porosity of the resultant skeletal structure may be increased. A more porous skeletal structure enables more effective formation of smaller polymer particles.

The size of the particles may further depend upon the quantity of addenda included in the second phase, and upon the size of pores generated.

Preferably the polyHIPE formed according to the preferred embodiment of the present invention has a porosity of at least 26% and preferably up to 95%, such as within the range 30-95%, and more preferably in the range 40-95%. In a most preferred embodiment, the polyHIPE formed may have a porosity in the range 60-90%.

The average pore size of the skeletal structure formed, especially in respect of the preferred embodiment in which a polyHIPE material is formed from a water-in-oil HIPE, is preferably up to about 10 μm diameter (more typically up to 2 μm as an upper limit), more preferably up to 1 μm, still more preferably up to 0.1 μm and most preferably in a range from 10 to 90 nm, and perhaps within a range of from 20 to 80 nm, or from 25 to 60 nm.

In order that particles may be more easily formed at the desired size, it is preferable that the preferred porosity and preferred pore size ranges mentioned above are both achieved. In this way, mechanical division or milling of the skeletal structure to achieve particles of the desired size is significantly easier.

A particular advantage of having a skeletal structure with a small pore size is that particles with some degree of internal porosity may be formed and it allows the size of such porous particles to be relatively small. Furthermore, ink or other material to be absorbed can be absorbed more quickly by a coating of such particles due the improved capillary action associated with the internal porosity of the particles.

The inventors have found that the shear to which the emulsion is subjected can be used to control the pore size of the resultant skeletal structure, and in particular, when using a mixer, the shear rate during mixing, for example in a Polytron™ high shear mixer, can be used to control the pore size in the resultant material.

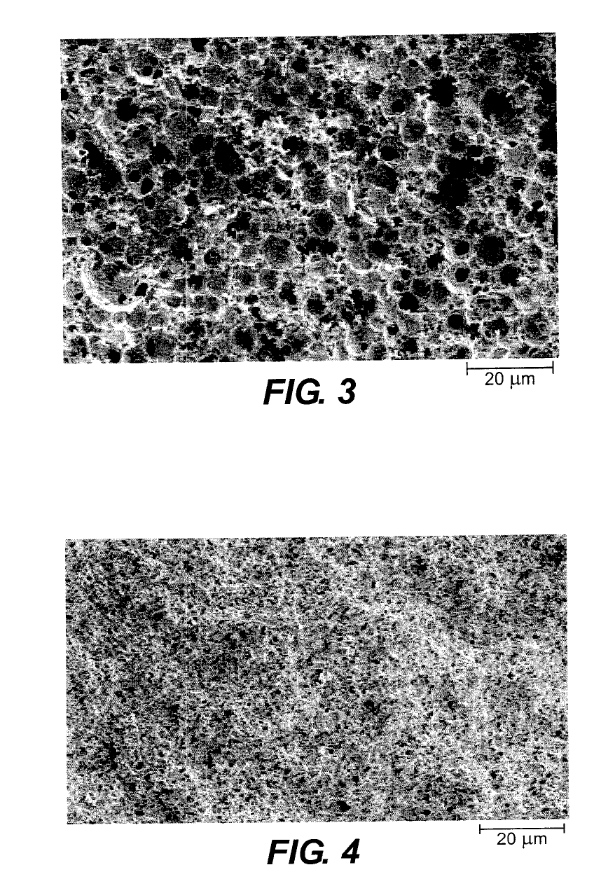

For example, in a water-in-oil HIPE according to the preferred embodiment of the invention, an increase in the shear rate of mixing applied to the emulsion prior to coating onto a support, of from 2000 to 6000 rpm resulted in a substantial decrease in pore size, as can be seen from FIGS. 3 to 6 and Example 2, without significantly affecting the overall pore volume of the resultant fluid-receiving layer.

Preferably, therefore, the process of generating an emulsion comprises mixing the phases in a mixer with a high shear rate, having a shear rate of, for example, greater than 1000 rpm, preferably greater than 2000 rpm, for example, in the range from 4000 rpm to 6000 rpm, but preferably at least 6000 rpm and more preferably at least 7000 rpm.

When preparing the emulsion, especially in large quantities, it may be beneficial to mix the emulsion at a first shear rate in order to establish an adequately mixed emulsion for a first period and then increase the shear rate to a rate according to the porosity desired in the resultant material as discussed above, for a second period rather than maintain the higher shear rate for the entire mixing time in order to prevent heat generated during the mixing process causing the polymerisation step to begin or to proceed to any great degree.

The use of the shear rate to control the pore size is particularly applicable to the formation of porous polymer particles from a porous polymer structure formed by polymerisation of a HIPE comprising a polymerisable monomer in the continuous phase (first phase). In particular, the use of a shear rate of, for example, 4000 to 6000 rpm may control the pore size of the porous polymer structure, or polyHIPE, formed to less than 5 μm and an increase in shear rate of from 2000 to 6000 rpm, for example, may result in pores being reduced in size from greater than 10 μm to less than 5 μm. The use of a shear rate of greater than 7000 may be used to control the pore size to be less than 1 μm. The control of pore size to be relatively small, e.g. 0.1 μm or less, for example, within the range 10 to 80 nm, may be beneficial in a variety of uses. The ability to control the pore size to be very small, e.g. within the range 10 to 80 nm is especially useful in forming an ink-receiving layer of an ink-jet receiver from the particles of the invention.

Particles prepared by the method of the invention may preferably have a degree of internal porosity, as mentioned above.

For small particles (e.g. 2 μm or less in diameter) to have internal porosity, the intra-particle pore sizes must necessarily be very small. While it is possible to produce such pore sizes, for example, by the use of high shear stirring, small intra-particle pores can also be produced through the use of a porogen in the emulsion. In Example 3 below, a porogen was used to generate intra-particle pores with a diameter of about 30 nm. In such cases, it is preferable that the pore size is less than 60 nm, more preferably less than 30 nm and most preferably from 3 to 30 nm.

The porogen may be incorporated into the first phase of the emulsion (e.g. the oil phase of a water-in-oil HIPE, according to the preferred embodiment). This can lead to the formation of particle that are themselves porous. The degree of porosity may be controlled according to the amount of and the identity of the one or more porogens used. Examples of suitable porogens include any organic solvent soluble in the oil phase but not substantially water soluble and the precise identity may depend upon the polymerisable monomer used, but examples might include hexane, cyclohexane, heptane and, preferably, toluene.

By utilising a porogen, therefore, it is possible to have two types of pores in the skeletal structure—pores formed by, for example, high shear stirring, which ease the formation/help define the size of particles formed therefrom; and pores formed by use of a porogen to give the particles internal porosity, which intra-particle pores are significantly smaller than the average particle diameter and preferably an order of magnitude smaller.

In order to form the polymeric particles (or polymeric particulate material) of the invention from the porous polymeric structure defined by the skeletal structure, which is described above, the structure is subjected to a mechanical dividing step. This typically involves a milling step. Typically, the polymeric structure is ground down to form large particles suitable for milling. Depending upon the intended functional application of the particulate material, the large ground particles may be used as is or further treated, typically by milling. The milling may take place using a rolling mill, for example, in the presence of milling media beads. The milling method used may be any suitable method as known in the art for producing the desired sized particles.

The method of mechanically dividing the polyHIPE material also plays an important part in the size of the particles obtained. For example, when the polyHIPE is mechanically divided by milling, the diameter of the milling media may limit the minimum particle size obtained. In addition, as shown in Examples 17 and 18 below, the addition of surfactant during the milling process can affect the final particle size.

Depending upon the intended use of the particulate material, the particles can be treated during or after the mechanical dividing or milling process. For example, the particles can be treated with surfactant during or after mechanically dividing or milling, preferably during mechanical dividing or milling since this has shown to have a more significant effect on the fluid uptake of coating made with such particles. In the case where the particles are formed from a hydrophobic polymer structure, typically they have a partial coverage of the surfactant that was present at the interface of the emulsion from which the hydrophobic polymer structure was formed rendering the surface partially hydrophilic, but also have areas of highly hydrophobic surface exposed from breaking down the hydrophobic structure. In such circumstances, applying a suitable surfactant during or after the mechanically dividing or milling process, but preferably during, can render those hydrophobic surfaces hydrophilic. This is particularly advantageous where the particles are to be used in the ink-receiving layer of an ink-jet receiver in that it enables aqueous based fluids to be absorbed by the receiving layer. Suitable and preferred surfactants in this regard include those discussed above for use in the formation of water-in-oil HIPEs.

Alternatively, for example, the particles can be washed during the mechanically dividing or milling process to remove any surfactant residual from the porous polymeric structure making process and reveal the surface properties of the material from which the particles are made. For example, hydrophobic particles having a partial residual coating of a surfactant may be washed to reveal an entirely hydrophobic surface. Optionally, depending upon the intended application of the particles of the invention, further treatment can be carried out after removal of residual surfactant, such as treatment with a further, different, surfactant or other surface property-modifying component.

Particles prepared according to the present invention can be used, as appropriate, for a range of applications. For example, polymer particles of this type may be used in ink cartridges, to immobilise the ink in the ink cartridge. Typically, ink cartridges for ink-jet printers have a foamed ink-immobiliser which effectively prevents the ink moving around the cartridge as the cartridge moves. However, for different sizes of ink cartridges, different sizes of foamed material needs to be prepared. The particles of the present invention would be ideal for adding to an ink-jet cartridge to prevent undesirable movement of ink in the cartridge since they provide a highly porous packed structure. Furthermore, polymeric particles prepared according to the method of the present invention would have the advantage that they could be added in varying amounts to ink-jet cartridges of varying sizes without having to manufacture different materials in each situation. Polymeric particles for this purpose may be larger than would be necessary for an ink-jet receiver and would preferably be up to 50 μm in diameter and preferably from 1 to 10 μm in diameter and therefore the average pore size of the skeletal structure from which they are formed may be of those general dimensions. Preferably, the particles for this purpose have a degree of internal porosity such that the ink capacity and ability to temporarily immobilise the ink is increased. For this purpose, particles with a hydrophobic surface would be beneficial in immobilising solvent based inks and particles with a hydrophilic surface would be beneficial in immobilising aqueous inks and so adding a suitable surfactant during the milling step is beneficial. Particles according to the invention, having hydrophobic or hydrophilic surface properties, may be used in cleaning up spills by absorbing spilt fluids. Preferably, for this purpose, the surface properties required are those of the material from which the particles are made. For example, for cleaning up spills of organic solvent, porous hydrophobic polymer particles having hydrophobic surface properties may be effectively utilised. Particles made according to the present invention may also be used for applications such as cavity wall insulation, in impact absorption and as porous filler.

The preferred application for the polymeric particulate material of the invention is, as discussed above, as a fluid receiving layer formed by coating the particles onto a support with a small amount of binder. Preferably, the fluid-receiving layer described above in accordance with the present invention, is an ink-receiving layer of an ink-jet receiver. Typically, for receiving aqueous based inks, the particles have hydrophilic surfaces.

The binder used may be any binder capable of effectively binding the polymeric particulate material to form a porous ink-receiving layer capable of retaining a pigment or dye, preferably a pigment, to form a printed image having good image properties. Suitable such binders include, for example, one or more of naturally occurring hydrophilic colloids and gums such as gelatin, albumin, guar, xantham, acacia and chitosan and their derivatives, functionalised proteins, functionalised gums and starches, cellulose ethers and their derivatives, such as hydroxyethyl cellulose, hydroxypropyl cellulose and carboxymethyl cellulose, polyvinyl oxazoline and polyvinyl methyloxazoline, polyoxides, polyethers, poly(ethylene imine), poly(acrylic acid), poly(methacrylic acid), n-vinyl amides including polyacrylamide and polyvinyl pyrrolidone, polyethylene oxide and polyvinyl alcohol, its derivatives and copolymers, and most preferably polyvinyl alcohol.

Preferably, the binder is present in the fluid receiving layer in an amount as a ratio of polymeric particulate material to binder of from 70:30 to 99:1, preferably 75:25 to 99:1 and still more preferably 85:15 to 99:1, although a minimum of up to 4% by weight of binder may be beneficial depending upon the particle size and shape.

Other components which may be present in the fluid receiving layer of an ink-jet receiver according to the present invention include, for example, a surfactant and a mordant. Suitable surfactants for use in the top layer, for example to improve coatability of the coating composition, depending upon the coating method used, include fluorosurfactants such as Lodyne® S100 or Zonyl® FSN, or a non-fluoro surfactants such as Olin® 10G.

Suitable mordants, which may be useful to bind the dye or pigment in the ink in the upper part of the ink-receiving layer in order to improve still further the image density, include, for example, a cationic polymer, e.g. a polymeric quarternary ammonium compound, or a basic polymer, such as poly(dimethylaminoethyl)methacrylate, polyalkylenepolyamines, and products of the condensation thereof with dicyanodiamide, amine-epichlorohydrin polycondensates, divalent Group 11 metal ions, lecithin and phospholipid compounds or any suitable mordant that is capable of assisting with fixing a dye material transferred to it. Examples of such mordants include vinylbenzyl trimethyl ammonium chloride/ethylene glycol dimethacrylate, poly(diallyl dimethyl ammonium chloride), poly(2-N,N,N-trimethylammonium)ethyl methacrylate methosulfate, poly(3-N,N,N-trimethylammonium)propyl chloride. A preferred mordant would be a quarternary ammonium compound.

An ink-receiving layer according to the present invention, and particularly the preferred embodiment of the invention in which a particles of a water-in-oil HIPE is utilised, is preferably formed having a thickness of 200 μm or less, more preferably 100 μm or less, still more preferably 50 μm or less and most preferably in the range of from 5 μm to 45 μm, the precise thickness depending also upon the degree of porosity of the ink-receiving layer formed, the design of the ink-jet receiver and the type and amount of ink to be used to print onto the ink-jet receiver.

According to the present invention, the particles may be coated onto the support, or as part of a multi-layer structure, by any suitable coating method. For example, the emulsion may be coated by blade, knife or extrusion coating techniques. One method of coating found to be effective is blade coating.

Suitable supports for use in the present invention include any suitable support for an ink-jet receiver, such as resin-coated paper, film base, acetate, polyethylene terephthalate (PET), a printing plate support such as aluminium foil, a latex-treated polyester or any other suitable support. Aluminium foil and latex-treated polyester have been found to be particularly effective supports for use in the preferred embodiment of the present invention in which a porous polymeric ink-receiving layer is formed using a water-in-oil HIPE.

Preferably, as mentioned above, the fluid-receiving layer is the ink-receiving layer and dyes in the ink may be retained by the material in that layer. The ink-jet receiver may comprise of only a support and the above described fluid-receiving layer as the ink-receiving layer and, optionally, a top coat.

Optionally, in a further aspect of the invention, particles composed of the porous cross-linked polymeric layer described above, especially the polyHIPE materials, may form part of a multi-layer structure having further layers above the porous cross-linked polymeric layer and/or below (i.e. between the porous cross-linked polymeric layer and the support). For example, the ink-jet receiver may comprise an additional layer below the porous cross-linked polymeric layer to improve adhesion between that layer and the support. The receiver may also comprise a further layer above the porous cross-linked polymeric layer described above, which may be a thinner (typically, more expensive) top layer. Such a top layer preferably has a glossy appearance and may be a relatively non-porous swellable polymer layer or, preferably, also has some porous character. Such a top layer may optionally be the ink-receiving layer, the porous cross-linked polymer layer being a fluid-receiving layer capable of retaining large quantities of liquid. Examples of porous ink-receiving layers that may suitably coated onto an ink-receiving layer as described above to provide a multi-layer ink-jet receiver include those porous ink-receiving layers comprising inorganic particulate materials and polymeric binders described in US-A-20020142140, US-A-20020142139 and US-A-20020142138, the disclosures of which are incorporated herein by reference.

In one embodiment of a multi-layer ink-jet receiver comprising particles composed of a porous cross-linked polymer emulsion described above, especially a polyHIPE, the receiver comprises more than one layer of particles composed of the porous cross-linked polymer emulsion of this type, each layer having a similar, but preferably a different, porosity and pore size, in a controlled manner such that ink may permeate through the layers of the receiver. The use of shear rate as described above may effectively control the variation of pore size and particle size in successive layers of the polymeric layers of the ink-jet receiver. Such a multi-layer structure may still further comprise a porous or non-porous overcoat as set out above.

According to a still further aspect of the invention there is provided an ink-jet receiver having an ink-receiving layer which ink-receiving layer comprises particles composed of a polyHIPE material. The particles of polyHIPE material as ink-receiving layer preferably has a thickness of 200 μm or less, more preferably 100 μm or less.

According to a still further aspect of the invention, there is provided a use of particles composed of a polyHIPE material in an ink-receiving layer of an ink-jet receiver. In each of these further aspects of the invention, the polyHIPE material may be prepared according to any suitable method and preferably by the method described above and may incorporate additional variants and features described.

Where an ink-jet receiver according to the present invention comprises an ink-receiving layer comprising porous polymeric particles, as described herein, the receiver may optionally be fused after printing by passing the printed receiver through a fusing device.

The invention will now be described by way of example only and without limitation as to the scope of the invention in the following Examples.

### EXAMPLES

### Example 1

### PolyHIPE Formation

Styrene (9 ml) and divinyl benzene (1 ml, 55% purity) were mixed with sorbitan monooleate (3 ml) in a 500 ml wide-mouth plastic bottle and stirred with a Polytron high shear mixer at 4000 rpm under a blanket of nitrogen gas. A solution of calcium chloride (1 g) and potassium persulfate (0.4 g) in water (90 ml) that had been deoxygenated by bubbling nitrogen through it for 20 minutes was then added over approximately 30 minutes by peristaltic pump to the stirred monomers. During this addition, the stirrer head was raised as the volume in the bottle increased to ensure efficient mixing. After addition was complete, the mixture was stirred a further 10 minutes at 5000 rpm.

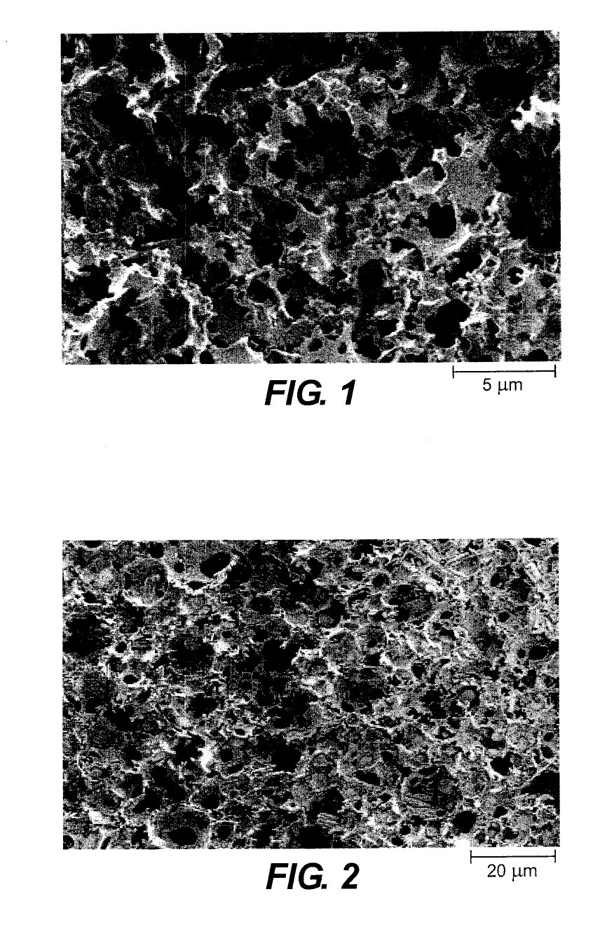

The HIPE formed was coated at 100 μm thickness onto aluminium foil, which was then laminated with a flat polyester sheet and cured in the oven at 70° C. for a minimum of 6 hours. The polyester laminate was removed and the coating allowed to dry at 60° C. for 2 hours. The resultant polyHIPE material was examined by Scanning Electron Microscopy. A Scanning Electron Micrograph of a polyHIPE material prepared according to Example 1 is shown in FIG. 1.

### Example 2

### PolyHIPE Formation

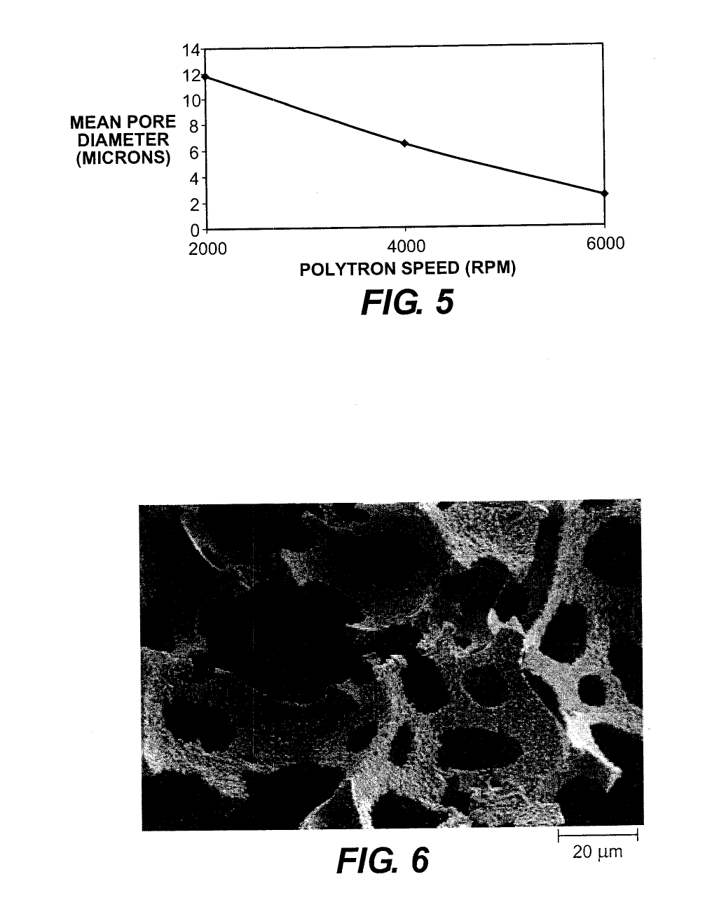

The effect of high shear stirring on the polymer structure was observed by preparing three polyHIPE samples using the method of Example 1, except that each sample was prepared using a different shear rate. During the addition of the aqueous phase, the Polytron mixer was run at 2000, 4000 and 6000 rpm. SEM of the resultant samples clearly shows the reduction in size of the pore structure with increasing shear rate—see FIG. 2 (shear rate 2000 rpm), FIG. 3 (shear rate 4000 rpm) and FIG. 4 (shear rate 6000 rpm). FIG. 5 shows a graphical relationship between shear rate and mean pore diameter.

### Example 3

### PolyHIPE Formation

Styrene (4.5 ml), divinyl benzene (0.5 ml, 55% purity) and sorbitan monooleate (3 ml) were dissolved in toluene (5 ml) and degassed with nitrogen bubbling for 20 minutes. This mixture was stirred at 300 rpm with a 6-bladed impeller (38 mm diameter) while a nitrogen degassed solution of calcium chloride (1 g) and potassium persulfate (0.2 g) was added over approximately 1 hour by peristaltic pump. Stirring was continued for a further 5 minutes and then a sample of the emulsion was placed in an oven at 60° C. for 24 hours to cure, followed by heating under vacuum at 75° C. to dry. From SEM (FIG. 6) it can be seen that not only has the typical polyHIPE structure been formed but that the polystyrene itself is porous.

### Example 4

### PolyHIPE Formation

A polyHIPE material was made following the method of Example 1 with replacement of water by a 1.1 wt % solution of PVA (MW 31-50,000, 98-99% hydrolysed) in water. The intermediate HIPE was stable and was hand-coated onto aluminium foil in the same manner as Example 1 to give the polyHIPE material after curing at 70° C. for 15 hours.

### Example 5

### PolyHIPE Formation

The method of Example 4 was repeated using a 2.5 wt % PVA in water solution. The HIPE was knife coated onto aluminium foil, laminated with polyester and cured in the usual way to give a polyHIPE material.

### Example 6

### PolyHIPE Formation

The method of Example 5 was repeated using a 5.6 wt % PVA in water solution to give a polyHIPE material.

### Example 7

### PolyHIPE Formation

Following the method of Example 1, an aqueous solution comprising 80 ml potassium persulfate (0.4 g) and calcium chloride (1 g) in water mixed with 10 ml of 50 wt % [3-(methacryloylamino)propyl]-trimethylammonium chloride in water was added to styrene (9 ml), divinyl benzene (1 ml) and sorbitan monooleate (3 ml) under nitrogen. The resultant cationic polymer-containing HIPE was hand coated, laminated, cured and dried to give a polyHIPE material.

### Example 8

### PolyHIPE Formation

The method of Example 1 was followed except that 1,4-butanediol dimethacrylate was used in place of divinyl benzene. A polyHIPE material was produced.

### Example 9

### PolyHIPE Formation

The method of Example 1 was followed except that glycerol monooleate was used in place of sorbitan monooleate. A polyHIPE material was produced.

### Example 10

### PolyHIPE Formation

Styrene (9 ml) and divinyl benzene (1 ml, 55% purity) were mixed with sorbitan monooleate (3 ml) and initiator AIBN (0.4 g, azo-bisisobutyronitrile) in a 250 ml wide-mouth plastic bottle and stirred with a Polytron high shear mixer at 4000 rpm under a blanket of nitrogen gas. A solution of calcium chloride (1 g) in water (90 ml) that had been deoxygenated by bubbling nitrogen through it for 20 minutes was then added over approximately 30 minutes by peristaltic pump to the stirred monomers. During this addition, the stirrer head was raised as the volume in the bottle increased to ensure efficient mixing. After addition was complete, the mixture was stirred a further 10 minutes at 5000 rpm.

The HIPE was coated at 100 μm thickness onto aluminium foil, laminated with a piece of flat polyester and cured in the oven at 70° C. for a minimum of 6 hours. The polyester laminate was removed and the coating allowed to dry at 60° C. for a minimum of 2 hours. The resultant coating was examined by Scanning Electron Microscopy (FIG. 7) and showed a slightly different polyHIPE structure.

### Example 11

### PolyHIPE Formation

A polyHIPE material was prepared using a redox couple initiator system as follows. A solution of ammonium persulfate (0.1 g) and calcium chloride (1 g) in water (45 ml) was sparged with nitrogen gas for 20 minutes. Another solution of sodium metabisulfite (0.08 g) in water (45 ml) was also sparged with nitrogen for 20 minutes. The two solutions were mixed and addition to the monomer and surfactant mixture immediately started following the method of Example 1. Three coatings were made on a latex-coated polyester base and laminated with clean polyester sheet then cured at different temperatures overnight: 25° C., 40° C. and 50° C. followed by drying at 60° C. after removing the polyester laminate sheet.

### Example 12

### PolyHIPE Formation

A polyHIPE material was prepared using initiator in both aqueous and organic phases as follows. The organic phase was made up as for Example 10 and the aqueous phase as for Example 1. Following the process described in Example 1, the polyHIPE structure was found to be less porous with less well-defined structure.

### Example 13

### PolyHIPE Formation

A polyHIPE material was prepared using a redox couple initiator in the aqueous phase and AIBN in the organic phase as follows. The organic phase was prepared as in Example 10 and the aqueous phase as in Example 11. The resultant polyHIPE material on aluminium foil was highly porous.

### Example 14

### PolyHIPE Formation

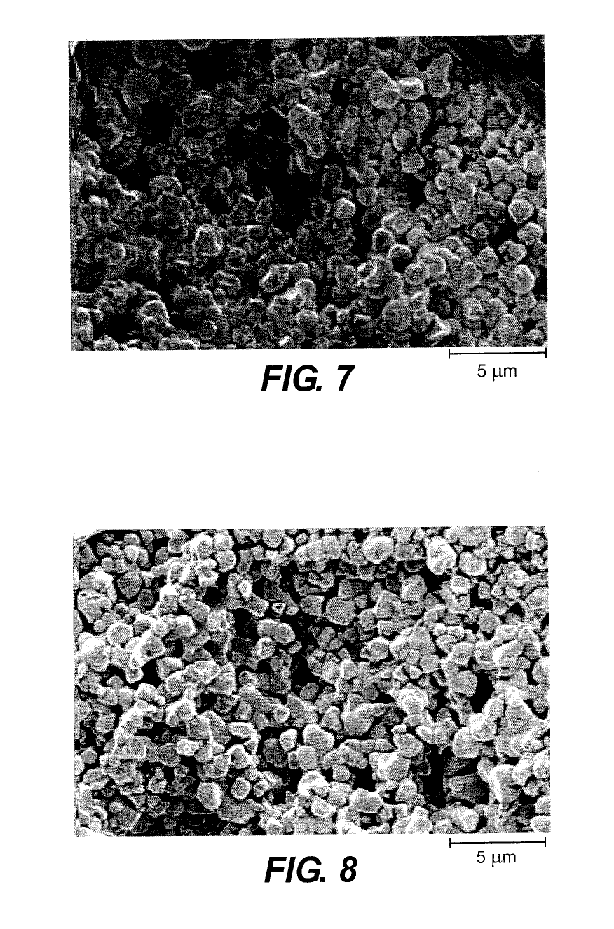

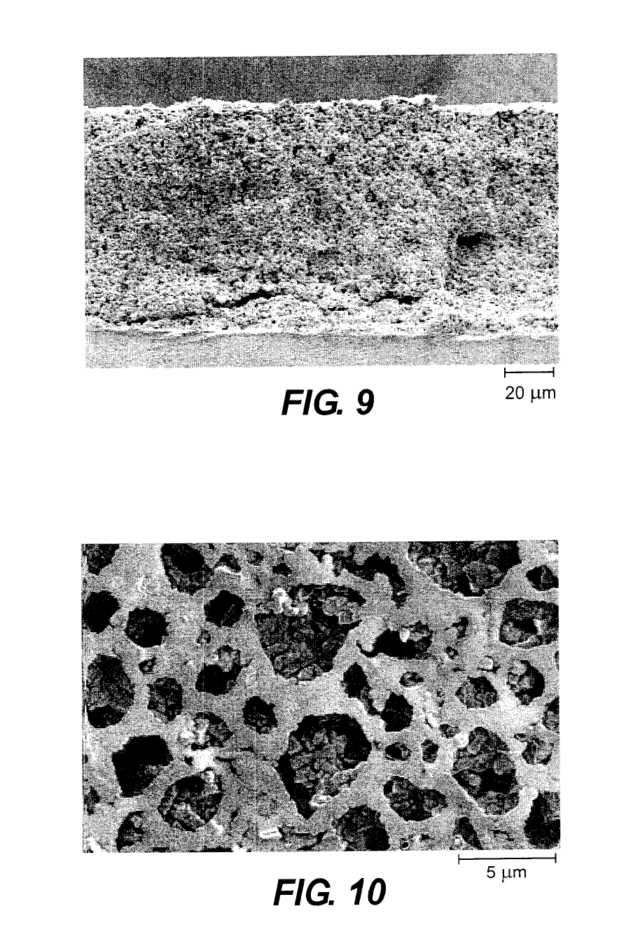

A polyHIPE material was prepared in which the HIPE was coated onto a support by extrusion coating. The HIPE was prepared according to Example 1 and a syringe pump and hopper was used to extrude a thin layer onto latex-coated polyester. The coated layer was then laminated with untreated polyester and cured at 70° C. for 12 hours and then the laminate removed and the sample dried at 60° C. for a minimum of 2 hours. The material had good porosity. FIG. 8 shows a top view SEM of such a material at 5000× magnification and FIG. 9 shows the same material as a cross-sectional SEM at 625× magnification. The effect of reducing the rate of extrusion (to 7 ml/min) can be seen in FIG. 10, which is a top view SEM at 5000× magnification and shows a coating that has a mixture of structures.

### Example 15

### Porosity of PolyHIPE Material

A practical assessment of the porosity of the poly(HIPE) materials was made in the following way. A substantial volume of the poly(HIPE) was fully immersed in water for 5 minutes. It was then carefully removed, weighed immediately and placed in a desiccator. The sample was reweighed periodically until a consistent reading was obtained which indicated the complete removal of water from the pore system. The porosity of the sample was calculated from these data together with a knowledge of the density of water and the component materials as:

$$Porosity ( \% ) = \frac{VoidVolume}{TotalVolume} \times 100$$

That is, in this case:

$$Porosity ( \% ) = \frac{WetVolume - DryVolume}{WetVolume} \times 100$$

TABLE 1
Measured porosity of various polyHIPE materials

| Example No. | Porosity |
|---|---|
| 1 | 84.5 |
| 2 (4000 rpm) | 84.9 |
| 2 (6000 rpm) | 84.2 |
| 3 | 90.0 |

As can be seen from Table 1, the ink-receiving layers formed according to Example 2, at 4000 and 6000 rpm, which had substantially reduced pore dimensions as compared with the ink-receiving layer formed according to Example 1, have approximately the same degree of porosity as that formed according to Example 1. The shear rate of mixing the emulsion therefore affects the pore size, without a significant effect on the overall porosity of the ink-receiving layer formed. The ink-receiving layer formed in Example 3, however, in which a porogen was added to the oil phase of the emulsion, had a substantially greater degree of porosity as compared with that prepared according to Example 1.

### Example 16

### PolyHIPE Formation

Styrene (9 ml) and divinyl benzene (1 ml, 55% purity) were mixed with sorbitan monooleate (3 ml) in a 500 ml wide-mouth plastic bottle and stirred with a Polytron high shear mixer at 4000 rpm under a blanket of nitrogen gas. A solution of calcium chloride (1 g) and potassium persulfate (0.4 g) in water (90 ml) that had been deoxygenated by bubbling nitrogen through it for 20 minutes was then added over approximately 30 minutes by peristaltic pump to the stirred monomers. During this addition, the stirrer head was raised as the volume in the bottle increased to ensure efficient mixing. After addition was complete, the mixture was stirred a further 10 minutes at 5000 rpm.

The HIPE formed was cured in the oven at 70° C. for a minimum of 6 hours. The plastic bottle was cut away to reveal the cylindrical block of polyHIPE, which was allowed to dry at 60° C. for 2 hours.

### Example 17

### PolyHIPE Particles

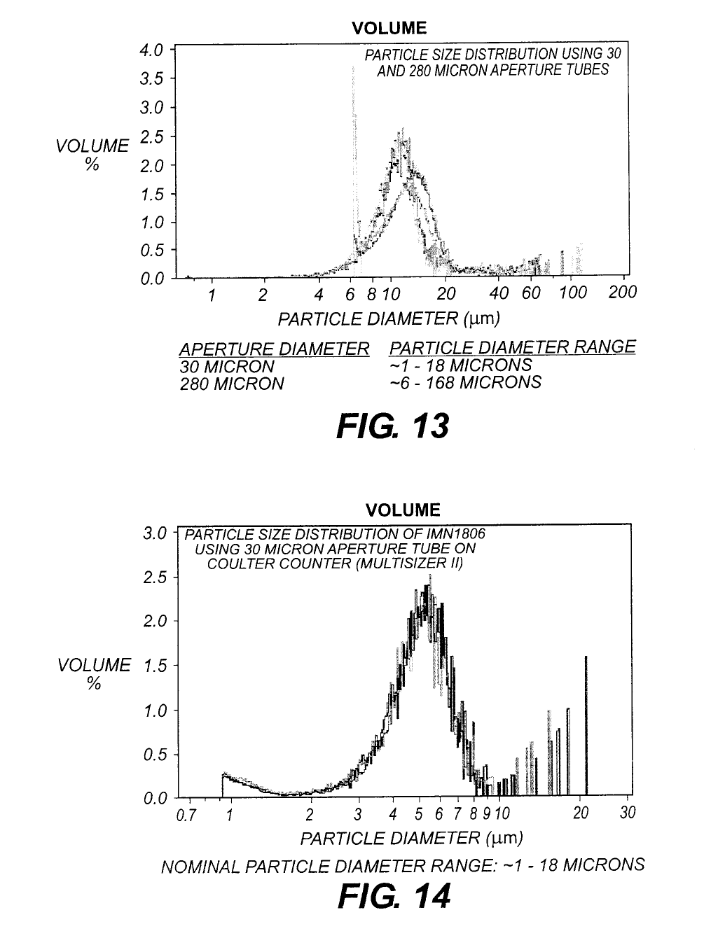

The polyHIPE material (4 g) prepared according to Example 16 was crushed using a mortar and pestle and introduced into a 250 ml brown glass jar with water (30 ml). The jar was topped up with zirconia milling media beads (0.6-0.8 mm diameter) to ¾ volume and sealed. After 10 days on a rolling mill, the sample was filtered through a metal mesh (150 μm) and washed with a further 10 ml water to give a theoretical 10 wt % suspension of polyHIPE particles in water. There were many large pieces of polyHIPE that had not been adequately reduced in size by the milling. However, the average particle size of those particles successfully reduced in size was in the region of 10-12 μm as can be seen in the particle size distribution graph in FIG. 13.

### Example 18

### PolyHIPE Particles

The dry polyHIPE material (4 g) prepared according to Example 16 was ground in a coffee-grinder mill to reduce the particle size before subjecting to a conventional milling step. The ground polyHIPE material was then introduced into a 250 ml brown glass jar with water (30 ml) and sodium oleylmethyl taurate (sodium OMT) surfactant (0.3 g). The jar was topped up with zirconia milling media beads (0.6-0.8 mm diameter) to ¾ volume and sealed. After 10 days on a rolling mill, the sample was filtered through a metal mesh (150 μm) and washed with a further 10 ml water to give a theoretical 10 wt % suspension of polyHIPE particles in water. Most of the polyHIPE passed through the 150 um mesh and the particles had an average size of 5 μm as measured by light scattering experiment (see the particle size distribution graph in FIG. 14).

### Example 19

### PolyHIPE Particles

PolyHIPE material was prepared from styrene (10 ml), sorbitan monooleate (3 ml) and water (90 ml) with potassium persulphate and calcium chloride according to the method of Example 16, except that no cross-linker (divinyl benzene) was used.

On removal from the plastic bottle, the material was slow to dry and somewhat fragile and crumbly in texture. The dried, uncrosslinked polyHIPE material (6 g) was milled as in Example 18.

### Example 20

### Coatings of PolyHIPE Particles

Coatings of polyHIPE particles prepared according to Examples 17 to 19 were made on a glossy, gel-subbed, resin-coated paper support. The coatings were made using a blade coater to produce coatings with laydowns of polyHIPE particles in the region of 15 g/m². The coating solutions were made-up by mixing the appropriate quantity of poly(vinyl alcohol), surfactant and polyHIPE dispersion. The poly(vinyl alcohol) used here as a binder was a high molecular weight polymer with a degree of hydrolysis of ˜88 mol %, such as Gohsenol GH 17 supplied by Nippon Gohsei Company, and was added at a rate of 15 wt % of the mass of the polyHIPE material. The surfactants were Olin 10G and Zonyl FSN, both of which were widely available commercially.

$$Porosity was calculated as \qquad Porosity ( \% ) = \frac{VoidVolume}{TotalVolume} \times 100 ,$$

where the Total Volume of the coating was determined by measuring the thickness of the coating using SEM cross-sectional images, and the Void Volume was calculated as the Total Volume minus the Coated Volume of material. The Coated Volume of material was determined from the density and weight of the coating.

Ink absorption was determined by applying onto the coating surface a 0.25 μl drop of magenta ink extracted from a typical commercial, piezo-electric, drop-on-demand, desktop inkjet printer, such as an Epson StylusPhoto 870 printer, and observing the rate of ink absorption. If the ink was not absorbed within two minutes, the coating was rated as ‘non-absorbing’ (N), otherwise it was rated absorbing (A).

Contact angle was estimated in the following way. A 1.0 μl droplet of water containing a marker dye was placed onto the coating surface using a micro-pipette. In all cases the droplet was not absorbed. The droplet was allowed to dry completely and the radius of the resulting dot was measured. The contact angle of the droplet was then estimated from a knowledge of the droplet volume (V) and the dot radius (r) using

$$r = {[ \frac{3 V}{π} \frac{{sin}^{3} ( θ )}{2 - 3 cos ( θ ) + {cos}^{3} ( θ )} ]}^{1 / 3}$$

The results obtained for porosity, contact angle and ink absorption for each of these coatings are set out in Table 2 below.

TABLE 2
Data obtained from coating polyHIPE particles

| | | | | Contact | Ink |
|---|---|---|---|---|---|
| | Coating | Milling | | Angle | Absorption |
| Example | Surfactant | surfactant | Porosity | (water) | (2 mins) |
| 17 | No | No | 52 | 75 | N |
| 17 | Yes | No | 48 | 45 | N |
| 18 | No | Yes | 57 | 14 | A |
| 19 | No | Yes | 55 | 14 | A |
| Comparative | Yes | N/A | 52 | 24 | A |

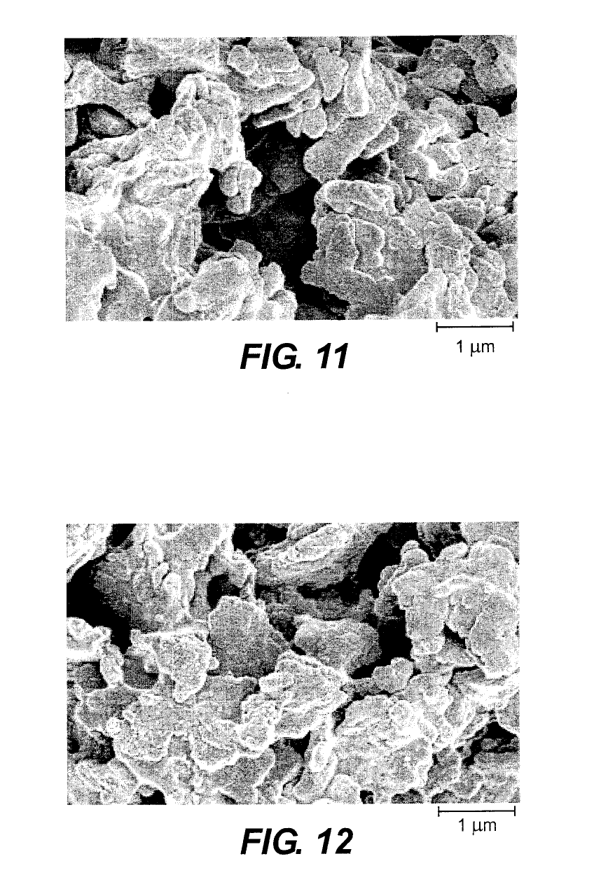

Cross-sectional SEM images of the coatings of particles from Examples 18 and 19 are shown in FIGS. 11 and 12.

It can be seen that

(i) Good porosity was obtained from coating these amorphous particles.
(ii) Adding surfactant before/during the milling process (Examples 18 and 19 only) enabled more rapid ink absorption.
(iii) The wettability of the coating, as reflected by the contact angle estimates, was significantly lower when surfactant was added for the milling process. This is consistent with the process of revealing hydrophobic polystyrene surface area when the pHIPE skeleton is broken during the milling process.

1. A polymeric particulate material made by a process comprising
generating an emulsion comprising a first phase having a first carrier fluid and a second phase having a second carrier fluid, said first and second carrier fluids being immiscible;
carrying out a first treatment to at least one component of said first phase to form and/or maintain a skeletal structure of said treated at least one component of said first phase; and
carrying out a second treatment to substantially remove said second carrier fluid
thereby generating a large capacity porous polymeric structure defined by said skeletal structure, and then mechanically dividing said porous polymeric structure to form polymeric particles.

2. The polymeric particulate material of claim 1, wherein said emulsion is a biphasic emulsion comprising an oil phase as said first phase and an aqueous phase as said second phase.

3. The polymeric particulate material of claim 1, wherein said emulsion is a high internal phase emulsion.

4. The polymeric particulate material of claim 1, wherein one component of said first phase is a polymerisable monomer and said first treatment is a polymerisation step for polymerising said polymerisable monomer thereby forming said skeletal polymer structure.

5. The polymeric particulate material of claim 4, wherein said polymerisation step is initiated by heating at least one initiator precursor being comprised in said aqueous phase and/or at least one initiator precursor being comprised in said oil phase.

6. The polymeric particulate material of claim 5, wherein said initiator precursor is in the aqueous phase and is potassium persulfate.

7. The polymeric particulate material of claim 2, wherein said first phase is said oil phase and said at least one polymerisable monomer comprises one or more of styrene, α-methylstyrene, chloromethylstyrene, vinylethylbenzene, vinyl toluene, 2-ethylhexyl acrylate, n-butyl acrylate, isobutyl acrylate, t-butyl acrylate, hexyl acrylate, n-butyl methacrylate, lauryl methacrylate, isodecyl methacrylate butadiene, isoprene, piperylene, allene, methyl allene, chloroallene, vinyl chloride, vinyl fluoride and polyfluoro-olefins.

8. The polymeric particulate material of claim 2, wherein said oil phase further comprises at least one cross-linker monomer.

9. The polymeric particulate material of claim 8, wherein said cross-linker monomer is divinyl benzene.

10. The polymeric particulate material of claim 2, wherein said emulsion further comprises in said oil phase a high internal phase emulsion stabilising surfactant comprising one or more of sorbitan monooleate and glycerol monooleate.

11. The polymeric particulate material of claim 1, wherein said first phase further comprises a porogen.

12. The polymeric particulate material of claim 2, wherein said emulsion is generated by mixing said oil phase and said aqueous phase in a mixer at a shear rate of greater than 2000 rpm.

13. The polymeric particulate material of claim 1, wherein said skeletal structure comprises pores of an average pore size of 0.1 μm or less.

14. The polymeric particulate material of claim 1, wherein said skeletal structure comprises a porous cross-linked polymeric material.

15. The polymeric particulate material of claim 1, wherein said polymeric particles formed by said mechanically dividing step are 0.1 μm or less.

16. An inkjet receiver comprising a porous fluid receiving layer comprising the polymeric particulate material of claim 1 and a binder material for coating onto a support in the manufacture of the ink-jet receiver.

17. The inkjet receiver of claim 16, wherein said binder is present in an amount of from 1 to 15% by weight of said fluid receiving layer.

18. A process for the preparation of a polymeric particulate material, said process comprising generating an emulsion comprising a first phase having a first carrier fluid and a second phase having a second carrier fluid, said first and second carrier fluids being immiscible;
carrying out a first treatment to at least one component of said first phase to form and/or maintain a skeletal structure of said treated at least one component of said first phase; and
carrying out a second treatment to substantially remove said second carrier fluid
thereby generating a large capacity porous polymeric structure defined by said skeletal structure, and then mechanically dividing said porous polymeric structure to form polymeric particles.
